(19) United States
(12) Patent Application Publication
(10) Pub. No.: US 2017/0189899 A1
(43) Pub. Date: Jul. 6, 2017

(54) MULTI-PIECE FLUID TRANSFER TIP

(71) Applicant: Priyanshu Gupta, Hornsby (AU)

(72) Inventor: Priyanshu Gupta, Hornsby (AU)

(21) Appl. No.: 15/388,095

(22) Filed: Dec. 22, 2016

Related U.S. Application Data
(60) Provisional application No. 62/272,912, filed on Dec. 30, 2015.

(51) Int. Cl. B01L 3/02; B01L 9/00

(52) U.S. Cl. CPC B01L 3/0275; B01L 9/543; B01L 3/021; B01L 3/02; B01L 2200/0689

(57) ABSTRACT

Improved pipette tips having sections, the pipette tips having a dis-assembled configuration and an assembled configuration. The dis-assembled configuration allows the pipette tips to be stored and transported when dis-assembled, saving space and allowing more convenient transport. The assembled configuration allows the full-sized pipette tips to be used in their most efficient form, without requiring additional space or difficult manipulation for their use. Cartridges carrying such improved pipette tips, systems including such improved pipette tips, kits providing such improved pipette tips, and methods for their use are disclosed. Cartridges and kits may also include or provide reagents, implements, samples, and combinations thereof, along with the improved pipette tips. The improved pipette tips provide advantages including improved fit within cartridges effective for ready insertion into automated sample analysis devices and systems.

This application claims priority to U.S. Provisional Application Ser. No. 62/272,912 filed Dec. 30, 2015 which is fully incorporated herein by reference for all purposes.

### BACKGROUND

### Background

Fluids conform to the shape of a vessel or conduit in which they are held, or are flowing. Fluids may be transferred via hollow conduits, for example, by flowing within the conduit from one end of the conduit to the other end of the conduit. In some instances, the conduit may be transported from one location to another, carrying fluid held within the conduit to that other location. Thus, fluids may be aspirated into a cavity of a vessel, such as a pipette tip, and the vessel transported to a different location, where the fluid may be expelled.

In addition to transporting fluid, a conduit or vessel, such as a pipette tip, may collect fluid, store fluid, alter (e.g., filter) fluid, and aid in the analysis of a fluid. However, the volume of fluid which may be collected, stored, altered, transported, or expelled, may depend on the geometry and composition of the conduit or vessel, such as a pipette. Conduits and vessels, such as pipettes, large enough to collect or carry large volumes may be difficult to manufacture, awkward to manipulate, difficult to store, or may present other problems to their use.

Accordingly, in view of the limitations of present designs and methods, improved pipette designs and improved methods for their use are desired.

### INCORPORATION BY REFERENCE

All publications, patents, and patent applications mentioned in this specification are herein incorporated by reference to the same extent as if each individual publication, patent, or patent application was specifically and individually indicated to be incorporated by reference.

### COPYRIGHT

This document contains material subject to copyright protection. The copyright owner (Applicant herein) has no objection to facsimile reproduction of the patent documents and disclosures, as they appear in the US Patent and Trademark Office patent file or records, but otherwise reserves all copyright rights whatsoever. The following notice shall apply: Copyright 2015 Theranos, Inc.

### SUMMARY

Applicant discloses herein improved fluid transfer devices, systems using such improved fluid transfer devices, methods of using such improved fluid transfer devices, methods of using systems using such improved fluids transfer devices, and kits including the improved fluid transfer devices. In embodiments, improved fluid transfer devices disclosed herein may serve as pipettes, and in embodiments may be pipette tips configured for use with fluid handling devices and systems, such as fluid handling devices which may be part of, or may be used with, automated sample analysis devices and systems.

Applicant discloses herein improved pipette tips having sections, the pipette tips having a dis-assembled configuration and an assembled configuration. The dis-assembled configuration allows the pipette tips to be stored and transported when dis-assembled, saving space and allowing more convenient transport. The assembled configuration allows the full-sized pipette tips to be used in their most efficient form, without requiring additional space or difficult manipulation for their use.

Cartridges carrying such improved pipette tips, systems including such improved pipette tips, kits providing such improved pipette tips, and methods for their use are disclosed. Cartridges and kits may also include or provide reagents, implements, samples, and combinations thereof, along with the improved pipette tips.

In at least some embodiments, the improved pipette tips provide advantages including improved fit within cartridges effective for ready insertion into automated sample analysis devices and systems.

In embodiments, improved implements for fluid collection are provided which comprise a plurality of sections, which sections may be stored in a disassembled configuration, and which may be assembled for use as a single implement for fluid collection. In embodiments, improved implements for fluid transfer are provided which comprise a plurality of sections, which sections may be stored in a disassembled configuration, and which may be assembled for use as a single implement for fluid transfer. In embodiments, improved implements for fluid alteration are provided which comprise a plurality of sections, which sections may be stored in a disassembled configuration, and which may be assembled for use as a single implement for fluid alteration. In embodiments, improved implements for fluid analysis are provided which comprise a plurality of sections, which sections may be stored in a disassembled configuration, and which may be assembled for use as a single implement for fluid analysis.

In embodiments, these improved implements for fluid collection, fluid transfer, fluid alteration, and fluid analysis comprise pipette tips. In embodiments, these improved pipette tips comprise a plurality of sections, which sections may be stored in a disassembled configuration, and which may be assembled for use as a single pipette tip. In embodiments, improved pipette tips disclosed herein may comprise two sections, which sections are configured to fit snugly together when assembled, and to form a single pipette tip suitable for use in collecting fluid, transferring fluid, altering fluid, or analyzing fluid. In embodiments, the improved pipette tips comprising two sections disclosed herein may be assembled and used for any other suitable use of a pipette.

In embodiments, improved pipette tips disclosed herein may comprise three sections, which sections are configured to fit snugly together when assembled, and to form a single pipette tip suitable for use in collecting fluid, transferring fluid, altering fluid, or analyzing fluid. In embodiments, the improved pipette tips comprising three sections as disclosed herein may be assembled and used for any other suitable use of a pipette. In embodiments, improved pipette tips disclosed herein may comprise four sections, which sections are configured to fit snugly together when assembled, and to form a single pipette tip suitable for use in collecting fluid, transferring fluid, altering fluid, or analyzing fluid. In embodiments, the improved pipette tips comprising four sections as disclosed herein may be assembled and used for any other suitable use of a pipette.

In embodiments, improved pipette tips disclosed herein may comprise multiple (more than three) sections, which sections are configured to fit snugly together when assembled, and to form a single pipette tip suitable for use in collecting fluid, transferring fluid, altering fluid, or analyzing fluid. In embodiments, the improved pipette tips comprising multiple (more than three) sections as disclosed herein may be assembled and used for any other suitable use of a pipette.

In embodiments, improved pipette tips disclosed herein, comprising two, three, or more than three, sections may have circular cross-sectional shapes (where the cross-section is taken perpendicular to the long axis of the assembled pipette tip, the long axis extending from one orifice of the pipette tip to the other orifice). In embodiments, improved pipette tips disclosed herein, comprising two, three, or more than three, sections may have roughly circular cross-sectional shapes. In embodiments, improved pipette tips disclosed herein, comprising two, three, or more than three, sections may have elliptical, or roughly elliptical, cross-sectional shapes. In embodiments, improved pipette tips disclosed herein, comprising two, three, or more than three, sections may have triangular cross-sectional shapes. In embodiments, improved pipette tips disclosed herein, comprising two, three, or more than three, sections may have square or rectangular cross-sectional shapes. In embodiments, improved pipette tips disclosed herein, comprising two, three, or more than three, sections may have cross-sectional shapes having five sides (e.g., pentagons). In embodiments, improved pipette tips disclosed herein, comprising two, three, or more than three, sections may have cross-sectional shapes having six sides (e.g., hexagons). In embodiments, improved pipette tips disclosed herein, comprising two, three, or more than three, sections may have cross-sectional shapes having seven sides (e.g., heptagons). In embodiments, improved pipette tips disclosed herein, comprising two, three, or more than three, sections may have cross-sectional shapes having eight sides (e.g., octagons). In embodiments, improved pipette tips disclosed herein, comprising two, three, or more than three, sections may have cross-sectional shapes having many (e.g., more than eight) sides.

In embodiments, improved pipette tips disclosed herein, comprising two, three, or more than three, sections may be made of plastic, glass, metal, carbon fiber, composite, or other material. In embodiments, improved pipette tips disclosed herein, comprising two, three, or more than three, sections may be made with two or more materials. In embodiments, one section of an improved pipette tips disclosed herein may be made with a material, or combination of materials, which is different than the material, or combination of materials, of which another section of the improved pipette tip is made.

In embodiments, the sections of the improved pipette tips are configured to fit snugly together when assembled, and thereby to form a single pipette tip. The location where two sections join to fit tightly together comprises a joint. In embodiments, the snug fit of the sections of the improved pipette tips comprises a fluid-tight fit, providing a fluid-tight joint, effective that fluid does not leak from the pipette tip when fluid is held in the pipette tip, or when fluid flows within the pipette tip. In embodiments, the snug fit of the sections of the improved pipette tips comprises an air-tight fit, providing an air-tight joint, effective that air does not leak into the pipette tip when suction is applied within the pipette tip, effective that the assembled pipette tip may be used to aspirate fluid. In embodiments, the joint of the sections of the improved pipette tips comprises a pipe-fit joint, in which the joining portions of the sections have tapered surfaces configured to provide an increasingly tight joint as one section is pressed into the other. In embodiments, the joint of the sections of the improved pipette tips comprises a pipe-fit joint, in which the joining portions of the sections have smooth tapered surfaces configured to provide an increasingly tight joint as one section is pressed into the other. In embodiments, the joint of the sections of the improved pipette tips comprises a pipe-fit joint, in which the joining portions of the sections have threaded tapered surfaces configured to provide an increasingly tight joint as one section is threaded into the other (such as but not limited to, by rotation so that the threads engage and provide a threaded joint).

In embodiments, the assembled pipette tip has a narrow cross-section, providing a long narrow bore pipette tip. In embodiments, the assembled pipette tip has a wide cross-section, providing a wide bore pipette tip. In embodiments, the assembled pipette tip has a composite cross-section, having a narrow cross-section portion and a wide cross-section, providing a long narrow bore portion and a wide bore portion. Providing two, three, or more sections of a pipette tip, which, when assembled forms a long narrow bore pipette tip having greater internal volume (where the internal volume is the volume within the cavity between the orifices of the assembled pipette tip) than would be possible with a shorter narrow bore pipette. Providing a long narrow bore pipette tip in sections allows the storing and transport of the sections in smaller cartridges, or in cartridges with shorter vertical dimensions when the pipette tip is provided in a vertical orientation in a cartridge.

Applicant discloses herein cartridges that carry dis-assembled pipette tips. Such cartridges may be configured to provide pipette tips to automated sample analysis devices and automated sample analysis systems. In embodiments, such cartridges may also be configured to provide assay reagents to automated sample analysis devices and automated sample analysis systems. In embodiments, such cartridges may also configured to provide assay implements (such as, e.g., cuvettes, filters, pads, or other implements) to automated sample analysis devices and automated sample analysis systems. In embodiments, such cartridges may also be configured to provide a sample, or portions of a sample, to automated sample analysis devices and automated sample analysis systems. In embodiments, such cartridges may be configured to provide assay reagents and implements; assay reagents and sample; implements and sample; assay reagents, implements, and sample; and other combinations of materials including one or more of assay reagents, implements, and sample to automated sample analysis devices and automated sample analysis systems.

Applicant discloses herein systems comprising cartridges that carry dis-assembled pipette tips. Applicant discloses herein systems comprising automated sample analysis devices and cartridges that carry dis-assembled pipette tips. Applicant discloses herein systems comprising automated sample analysis systems and cartridges that carry dis-assembled pipette tips. Such cartridges may include any of the cartridges disclosed herein, including cartridges configured to further provide assay reagents, assay implements (such as, e.g., cuvettes, filters, pads, or other implements), a sample, or portions of a sample, and other combinations of materials including one or more of assay reagents, implements, and sample to automated sample analysis devices and automated sample analysis systems.

Applicant discloses herein kits comprising pipette tips as disclosed herein; in embodiments, the kits may comprise dis-assembled pipette tips. Applicant discloses herein kits comprising pipette tips as disclosed herein; in embodiments, the kits may comprise assembled pipette tips. Applicant discloses herein kits comprising pipette tips as disclosed herein; in embodiments, the kits may comprise both assembled pipette tips and dis-assembled pipette tips. Applicant discloses herein kits comprising pipette tips having sections as disclosed herein, and further comprising one or more pipette tip without sections.

In embodiments, such kits as disclosed herein comprising pipette tips may further include one or more of: a cartridge; an assay reagent; an assay implement (such as, e.g., a cuvette, a filter, a pad, or other implement); a sample; a control for use in comparison with a sample or for calibration of an automated sample analysis device or system; and combinations thereof.

The improved pipette tips, cartridges, devices, systems, and kits, and the methods of using them disclosed herein, provide advantages over the art. For example, long narrow pipettes must be long in order to hold sufficient fluid volume for analysis; thus, a cartridge holding such a long narrow pipette tip, or an automated sample analysis device or system using such a pipette tip, must be of sufficient size to accommodate the length of the pipette tip. However, in order to effectively provide such a long narrow pipette to an automated sample analysis device or system, such a long narrow pipette tip must typically fit into a slot or other entry port or docking mechanism of an automated sample analysis device or system. However, in order to effectively interface with automated pipette handling mechanisms, such a long narrow pipette tip must be provided in an orientation compatible with the pipette handling mechanism, typically an upright orientation.

Accordingly, Applicant discloses devices, systems, kits, and methods providing and utilizing advantageous fluid transfer devices having features described herein.

In embodiments, Applicant discloses a fluid transfer device comprising: a first section having a first internal bore, a proximal portion configured to operably engage with a fluid handling apparatus of an automated sample analysis device, and a distal portion, and a second section having a second internal bore, a proximal portion configured to operably engage with said distal portion of said first section, and a distal portion comprising a tip having an aperture fluidically connected with said second internal bore, said first section and said second section being configured for assembly together in an assembled configuration, wherein in said assembled configuration the distal portion of the first section is operably engaged with said proximal portion of said second section, effective to provide an assembled fluid transfer device; wherein in said assembled fluid transfer device said first internal bore is fluidically connected with said second internal bore, whereby said assembled fluid transfer device comprises a composite internal bore comprising the first internal bore and the second internal bore, wherein said composite internal bore provides a continuous fluid connection between said aperture and said a proximal portion of the first section.

In embodiments, the fluid transfer device as disclosed herein may comprise a distal portion of said first section that is configured to fit within said proximal portion of said second section, thereby providing operable engagement between said first and second sections to provide a fluid transfer device in said assembled configuration.

In embodiments, the fluid transfer device as disclosed herein may comprise a proximal portion of said second section that is configured to fit within said distal portion of said first section, thereby providing operable engagement between said first and second sections to provide a fluid transfer device in said assembled configuration.

In embodiments, Applicant discloses a fluid transfer device comprising:

a first section having a first internal bore, a proximal portion configured to operably engage with a fluid handling apparatus of an automated sample analysis device, and a distal portion,

a second section having a second internal bore, a proximal portion configured to operably engage with said distal portion of said first section, and a distal portion, and

a third section having a third internal bore, a proximal portion configured to operably engage with said distal portion of said second section, and a distal portion comprising a tip having an aperture fluidically connected with said third internal bore,

said first section, said second section, and said third section being configured for assembly together in an assembled configuration, wherein in said assembled configuration the distal portion of the first section is operably engaged with said proximal portion of said second section, and said distal portion of the second section is operably engaged with said proximal portion of said third section, effective to provide an assembled fluid transfer device;

wherein in said assembled fluid transfer device said first internal bore is fluidically connected with said second internal bore and with said third internal bore; said second internal bore is fluidically connected with said first internal bore and with said third internal bore; and said third internal bore is fluidically connected with said first internal bore and with said second internal bore;

whereby said assembled fluid transfer device comprises a composite internal bore comprising the first internal bore, the second internal bore, and the third internal bore, wherein said composite internal bore provides a continuous fluid connection between said aperture and said a proximal portion of the first section.

In embodiments of fluid transfer devices having features as disclosed herein, a distal portion of said first section may be configured to fit within said proximal portion of said second section, and a distal portion of said second section may be configured to fit within said proximal portion of said third section, thereby providing operable engagement between said first, second, and third sections to provide a fluid transfer device in said assembled configuration.

In embodiments of fluid transfer devices having features as disclosed herein, a proximal portion of said second section may be configured to fit within said distal portion of said first section, and a proximal portion of said third section may be configured to fit within said distal portion of said second section, thereby providing operable engagement between said first, second, and third sections to provide a fluid transfer device in said assembled configuration.

In embodiments of fluid transfer devices having features as disclosed herein, a proximal portion of said second section may be configured to fit within said distal portion of said first section, and a distal portion of said second section may be configured to fit within said proximal portion of said third section, thereby providing operable engagement between said first, second, and third sections to provide a fluid transfer device in said assembled configuration.

In embodiments of fluid transfer devices having features as disclosed herein, a distal portion of said first section may be configured to fit within said proximal portion of said second section, and a proximal portion of said third section may be configured to fit within said distal portion of said second section, thereby providing operable engagement between said first, second, and third sections to provide a fluid transfer device in said assembled configuration.

In embodiments, Applicant discloses a system comprising a fluid transfer device as disclosed herein and a cartridge, said cartridge configured to hold said fluid transfer device in a dis-assembled configuration, wherein the cartridge holds each of said first section and said second section of the fluid transfer device separately. In embodiments of a system disclosed herein, said cartridge may be configured to hold a plurality of fluid transfer devices. In embodiments of a system disclosed herein, said cartridge may hold each of said plurality of fluid transfer devices in a dis-assembled configuration.

In embodiments, Applicant discloses a system comprising: a fluid transfer device as disclosed herein; a cartridge, said cartridge configured to hold said fluid transfer device in a dis-assembled configuration, wherein the cartridge holds each of said first section and said second section of the fluid transfer device separately; and an automated sample analysis device. In embodiments of a system disclosed herein, said cartridge may be configured to hold a plurality of fluid transfer devices. In embodiments of a system disclosed herein, said cartridge holds each of said plurality of fluid transfer devices in a dis-assembled configuration.

Applicant further discloses herein kits, including a kit containing a fluid transfer device as disclosed herein, a cartridge configured to hold said fluid transfer device in a dis-assembled configuration, wherein the cartridge holds each of said first section and said second section of the fluid transfer device separately, and instructions for the use of said fluid transfer device.

Applicant further discloses a kit containing a fluid transfer device as disclosed herein, a cartridge configured to hold said fluid transfer device in a dis-assembled configuration, wherein the cartridge holds each of said first section and said second section of the fluid transfer device separately, and a reagent for use in an assay performed by an automated sample analysis device.

In embodiments, Applicant discloses herein methods, including, for example, a method of delivering a fluid transfer device to an automated sample analysis device, comprising: Placing a first section of a fluid transfer device in a cartridge, wherein said cartridge is configured to operably engage with an automated sample analysis device; Placing a second section of a fluid transfer device in said cartridge; Engaging said cartridge with said automated sample analysis device, effective to deliver said fluid transfer device to said automated sample analysis device. In embodiments of methods disclosed herein, said engaging said cartridge with said automated sample analysis device comprises inserting at least a portion of said cartridge into said automated sample analysis device. In embodiments of methods disclosed herein, the methods further comprise an assembling step, wherein the automated sample analysis device assembles said fluid transfer device effective to provide an assembled fluid transfer device. In embodiments of methods disclosed herein, the methods further comprise the automated sample analysis device performing an assay, wherein performance of said assay by said automated sample analysis device comprises use of said assembled fluid transfer device. In embodiments of methods disclosed herein, the cartridge further comprises a reagent for use in an assay performed by said automated sample analysis device. In embodiments of methods disclosed herein, the methods further comprising the automated sample analysis device performing an assay, wherein performance of said assay by said automated sample analysis device comprises use of said fluid transfer device in an assembled configuration. In embodiments of methods disclosed herein, the methods further comprising said automated sample analysis device performing an assay, wherein performance of said assay by said automated sample analysis device comprises use of said reagent. In embodiments of methods disclosed herein, the methods further comprising said automated sample analysis device performing an assay, wherein performance of said assay by said automated sample analysis device comprises use of said fluid transfer device in an assembled configuration and use of said reagent.

The methods, devices, and systems disclosed herein provide advantages over prior methods, devices, and systems. For example, the improved pipette tips comprising sections disclosed herein overcome such problems associated with the transport and use of pipette tips by allowing dis-assembly of the pipette tips into sections which readily fit in cartridges, and which are readily inserted into or otherwise engaged by automated sample analysis devices or systems, while allowing their assembly into full-sized, useful pipette tips for use. In embodiments, a very long pipette tip may be preferred for some applications; providing an improved pipette tip comprising two, or three, or more sections allows the use of a long pipette tip in an assembled configuration, while allowing ready storage and transfer of the long pipette tip in smaller, more convenient cartridges or other containers in a dis-assembled configuration. Fluid transfer devices, such as pipette tips, may be provided having steep tapers, shallow tapers, wide bores, narrow bores, long shafts, or other characteristics which may all be accommodated by the improved fluid transfer devices (e.g., pipette tips) disclosed herein, having a dis-assembled configuration and having an assembled configuration. The improved fluid transfer devices (e.g., pipette tips) disclosed herein may be stored in a orientation most suitable for use by automated sample analysis devices; for example, where a cartridge carries a pipette tip for supply to an automated sample analysis device, it is typically most useful for the pipette tip to be oriented perpendicularly to an operational axis of a fluid handling apparatus (e.g., perpendicular to an axis of motion of a nozzle configured to engage a pipette tip). However, where a long pipette tip is required, it may be impractical or impossible to place the long pipette tip in such an orientation, due to size constraints, or due to mechanical (e.g., range of motion) restraints, or other factors. The improved fluid transfer devices (e.g., pipette tips) disclosed herein may be dis-assembled into sections, and the sections may be sized so as to avoid or overcome such constraints, restraints, or other factors. The improved fluid transfer devices (e.g., pipette tips) disclosed herein may be dis-assembled into sections, and the sections may be oriented so as to avoid or overcome such constraints, restraints, or other factors. The improved fluid transfer devices (e.g., pipette tips) disclosed herein may be stored in a dis-assembled configuration; may be transported in a dis-assembled configuration; may be provided to an automated sample analysis device in a dis-assembled configuration; and may be assembled by the automated sample analysis device for use in performance of an assay, e.g., a diagnostic assay performed on a biological sample such as a blood or urine sample. Thus, the fluid transport devices disclosed herein may be stored, transported, and delivered in an orientation most suitable for use by automated sample analysis devices, and then may be assembled for use by such automated sample analysis devices.

Accordingly, the present fluid transfer devices as disclosed herein provide multiple advantages over unitary pipette tips which cannot be dis-assembled into sections and must be stored, transferred, and provided to automated sample analysis devices in a single cumbersome form.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1A shows a schematic perspective illustration of a pipette tip having features disclosed herein, the pipette tip having two sections. The pipette tip is shown in dis-assembled configuration.

FIG. 1B shows a schematic perspective illustration of a pipette tip having features disclosed herein, the pipette tip having two sections. The pipette tip is shown in assembled configuration.

FIG. 1C shows a schematic cross-sectional illustration of the assembled pipette tip of FIG. 1B. The cross-section of the pipette tip is taken along the line 1C-1C shown in FIG. 1B and illustrates the outer and inner surfaces of the upper section of the pipette tip of FIGS. 1A and 1B, and illustrates the bore within the inner surface of the pipette tip (defined in this view by the bore of the upper section).

FIG. 1D shows a schematic cross-sectional illustration of the assembled pipette tip of FIG. 1B. The cross-section of the pipette tip is taken along the line 1D-1D shown in FIG. 1B and illustrates the outer and inner surfaces of the upper section; the outer and inner surfaces of the lower section; and illustrates the bore within the inner surface of the pipette tip (defined in this view by the bore of the lower section).

FIG. 1E shows a schematic cross-sectional illustration of the assembled pipette tip of FIG. 1B. The cross-section of the pipette tip is taken along the line 1E-1E shown in FIG. 1B and illustrates the outer and inner surfaces of the lower section of the pipette tip of FIGS. 1A and 1B, and illustrates the bore within the inner surface of the pipette tip (defined in this view by the bore of the lower section).

FIG. 2A shows a schematic illustration of a cartridge containing a (dis-assembled) pipette tip having features as disclosed herein.

FIG. 2B shows a schematic illustration of a cartridge containing two (dis-assembled) pipette tips having features as disclosed herein.

FIG. 2C shows a schematic illustration of a cartridge containing a (dis-assembled) pipette tip having features as disclosed herein and containing a sample.

FIG. 2D shows a schematic illustration of a cartridge containing two (dis-assembled) pipette tips having features as disclosed herein as disclosed herein and containing a sample.

FIG. 3 shows a schematic illustration of a system including a cartridge containing two (dis-assembled) pipette tips having features as disclosed herein. The cartridge may optionally also contain a reagent, an implement, and a sample.

FIG. 4A shows a schematic perspective illustration of a wide pipette tip having features disclosed herein, the pipette tip having two sections. The pipette tip is shown in assembled configuration.

FIG. 4B shows a schematic cross-sectional view, the cross-section taken along line 4B-4B shown in FIG. 4A, showing the pipette tip in an assembled configuration.

FIG. 4C shows a schematic perspective illustration of a narrow pipette tip having features disclosed herein, the pipette tip having two sections. The pipette tip is shown in assembled configuration.

FIG. 4D shows a schematic cross-sectional view, the cross-section taken along line 4D-4D shown in FIG. 4C, showing the pipette tip in an assembled configuration.

FIG. 4E shows a schematic perspective illustration of a pipette tip having two sections and having multiple widths, having a wider section (upper) and a narrower section (lower), the narrow section including portions having different tapers. The pipette tip is shown in assembled configuration.

FIG. 4F shows a schematic cross-sectional view, the cross-section taken along line 4F-4F shown in FIG. 4E, showing the pipette tip in an assembled configuration.

FIG. 4G shows a schematic cross-sectional view, the cross-section taken along line 4G-4G shown in FIG. 4E, showing the pipette tip in an assembled configuration.

FIG. 4H shows a schematic cross-sectional view, the cross-section taken along line 4H-4H shown in FIG. 4E, showing the pipette tip in an assembled configuration.

FIG. 5A shows a schematic perspective illustration of a pipette tip having features disclosed herein, the pipette tip having three sections. The pipette tip is shown in assembled configuration.

FIG. 5B shows a schematic perspective illustration of a pipette tip having features disclosed herein, the pipette tip having four sections. The pipette tip is shown in assembled configuration.

### DETAILED DESCRIPTION

It is to be understood that both the foregoing general description and the following detailed description are exemplary and explanatory only and are not restrictive of the invention, as claimed. It may be noted that, as used in the specification and the appended claims, the singular forms “a”, “an” and “the” include plural referents unless the context clearly dictates otherwise. Thus, for example, reference to “a material” may include mixtures of materials, reference to “a compound” may include multiple compounds, and the like. References cited herein are hereby incorporated by reference in their entirety, except to the extent that they conflict with teachings explicitly set forth in this specification.

In this specification and in the claims which follow, reference will be made to a number of terms which shall be defined to have the following meanings:

“Optional” or “optionally” means that the subsequently described circumstance may or may not occur, so that the description includes instances where the circumstance occurs and instances where it does not. For example, if a device optionally contains a feature for a sample collection unit, this means that the sample collection unit may or may not be present, and, thus, the description includes both structures wherein a device possesses the sample collection unit and structures wherein sample collection unit is not present.

As used herein, the terms “substantial” means more than a minimal or insignificant amount; and “substantially” means more than a minimally or insignificantly. Thus, for example, the phrase “substantially different”, as used herein, denotes a sufficiently high degree of difference between two numeric values such that one of skill in the art would consider the difference between the two values to be of statistical significance within the context of the characteristic measured by said values. Thus, the difference between two values that are substantially different from each other is typically greater than about 10%, and may be greater than about 20%, preferably greater than about 30%, preferably greater than about 40%, preferably greater than about 50% as a function of the reference value or comparator value.

As used herein, a “sample” may be but is not limited to a blood sample, or a portion of a blood sample, may be of any suitable size or volume, and is preferably of small size or volume. In some embodiments of the assays and methods disclosed herein, measurements may be made using a small volume blood sample, or no more than a small volume portion of a blood sample, where a small volume comprises no more than about 5 mL; or comprises no more than about 3 mL; or comprises no more than about 2 mL; or comprises no more than about 1 mL; or comprises no more than about 500 μL; or comprises no more than about 250 μL; or comprises no more than about 100 μL; or comprises no more than about 75 μL; or comprises no more than about 50 μL; or comprises no more than about 35 μL; or comprises no more than about 25 μL; or comprises no more than about 20 μL; or comprises no more than about 15 μL; or comprises no more than about 10 μL; or comprises no more than about 8 μL; or comprises no more than about 6 μL; or comprises no more than about 5 μL; or comprises no more than about 4 μL; or comprises no more than about 3 μL; or comprises no more than about 2 μL; or comprises no more than about 1 μL; or comprises no more than about 0.8 μL; or comprises no more than about 0.5 μL; or comprises no more than about 0.3 μL; or comprises no more than about 0.2 μL; or comprises no more than about 0.1 μL; or comprises no more than about 0.05 μL; or comprises no more than about 0.01 μL.

As used herein, the term “point of service location” may include locations where a subject may receive a service (e.g. testing, monitoring, treatment, diagnosis, guidance, sample collection, ID verification, medical services, non-medical services, etc.), and may include, without limitation, a subject's home, a subject's business, the location of a healthcare provider (e.g., doctor), hospitals, emergency rooms, operating rooms, clinics, health care professionals' offices, laboratories, retailers [e.g. pharmacies (e.g., retail pharmacy, clinical pharmacy, hospital pharmacy), drugstores, supermarkets, grocers, etc.], transportation vehicles (e.g. car, boat, truck, bus, airplane, motorcycle, ambulance, mobile unit, fire engine/truck, emergency vehicle, law enforcement vehicle, police car, or other vehicle configured to transport a subject from one point to another, etc.), traveling medical care units, mobile units, schools, day-care centers, security screening locations, combat locations, health assisted living residences, government offices, office buildings, tents, bodily fluid sample acquisition sites (e.g. blood collection centers), sites at or near an entrance to a location that a subject may wish to access, sites on or near a device that a subject may wish to access (e.g., the location of a computer if the subject wishes to access the computer), a location where a sample processing device receives a sample, or any other point of service location described elsewhere herein.

Applicant discloses herein fluid transfer devices, including pipette tips, which include two, or more, sections which may be assembled together to form a single fluid transfer device (e.g., a single pipette tip). For example, a pipette tip may be useful in assays for analyzing biological samples, including blood samples, urine samples, sweat samples, tear samples, samples from throat swabs, nasal swabs, nasopharyngeal swabs, lavages, or samples of other bodily fluids.

Fluid transfer devices, including pipette tips, as disclosed herein may be made of any suitable material or combination of materials. In embodiments, fluid transfer devices, including pipette tips, may be made of combinations of materials. In embodiments, fluid transfer devices, including pipette tips, may be made composite materials, including co-polymers. In embodiments, fluid transfer devices, including pipette tips, may be made of polystyrene or another moldable or machinable plastic. In embodiments, fluid transfer devices, including pipette tips, may be made of polymeric materials. Non-limiting examples of polymeric materials include polystyrene, polycarbonate, polypropylene, polydimethysiloxanes (PDMS), polyurethane, polyvinylchloride (PVC), polysulfone, polymethylmethacrylate (PMMA), acrylonitrile-butadiene-styrene (ABS), and glass. In embodiments, fluid transfer devices, including pipette tips, may be made of carbon fiber, or resin, or metal, or other materials.

Where a pipette tip is provided to an automated sample analysis device in a cartridge, there may be constraints on the acceptable size (e.g., height) of the cartridge. For example, where a cartridge is used to provide a pipette tip to an automated sample analysis device by inserting the cartridge into a slot or other engagement mechanism of the automated sample analysis device, there may be a constraint (e.g., an upper limit) on the length of the pipette tip provided. A pipette tip provided in a cartridge may be oriented so that it may be picked up by a fluid handling device, typically in an orientation perpendicular to the working end (e.g., a nozzle) of the fluid handling device. However, if a pipette tip is too long, it may only fit into a cartridge in an angled, or even sideways, configuration, making engagement with the fluid handling device difficult or impossible. As disclosed herein, Applicant has solved this problem by providing fluid transfer devices such as pipette tips which may be dis-assembled and placed in dis-assembled configuration in a cartridge, for assembly by (e.g., within) an automated sample analysis device following operable engagement of the cartridge by the automated sample analysis device (e.g., placement of the cartridge in a slot or other orifice of the automated sample analysis device).

Accordingly, Applicant provides herein methods, devices, and system for reducing the height of a cartridge carrying a fluid transfer device such as a pipette tip. In embodiments, a pipette tip may be shortened by dividing the pipette tip into sections (e.g. two sections, or three sections, or more sections). In such embodiments, a section of the pipette tip interacts with the fluid handling device, and a section of the pipette tip includes an aperture for aspirating and for expelling a fluid (e.g., a fluid sample such as a blood sample). Optionally, the cartridge has a vertical height less than a vertical height of the multi-piece pipette tip when such tip is fully assembled.

The sections of the pipette tip may be placed independently in a cartridge, thereby saving vertical space. Such cartridges, carrying such (sectional) pipette tips, may be of smaller size than cartridges which carry unitary pipette tips of full length. Cartridges carrying such (sectional) pipette tips may thus be smaller, and may also have room to include other, and may be able to include more components in the cartridge.

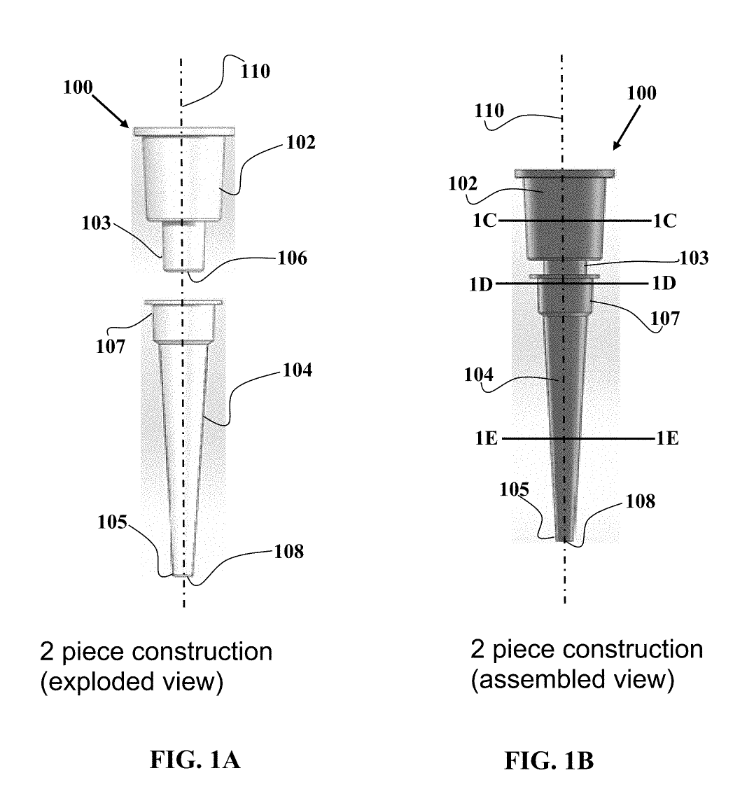

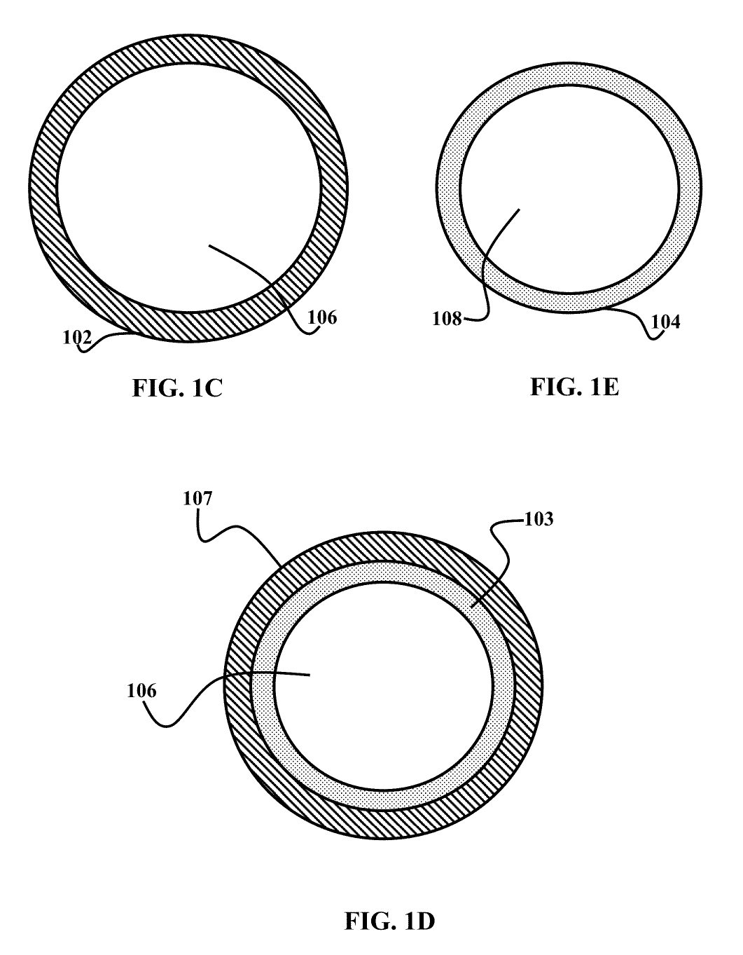

FIG. 1A shows a schematic perspective illustration of a pipette tip having features disclosed herein, the pipette tip having two sections. The pipette tip is shown in dis-assembled configuration. Pipette tip 100, shown dis-assembled in FIG. 1A, has an upper section 102, which upper section 102 has an insert portion 103 configured to engage with the receptacle portion 107 of lower section 104 of pipette tip 100. The distal end of pipette tip 100 has an aperture 105 leading to interior bore 108 within the lower section 104. Upper section 102 has an internal bore 106. Axis 110 indicates the long axis of the pipette tip 100; translation of section 102 and/or section 104 along axis 11 brings the two sections into contact and allows their assembly into the assembled configuration.

The assembled configuration of pipette tip 100 is shown in FIG. 1B. Sectional lines 1C-1C, 1D-1D, and 1E-1E indicate the levels at which cross-sections of the assembled pipette tip 100 are illustrated in FIGS. 1C, 1D, and 1E.

FIG. 1C shows a schematic cross-sectional illustration of the assembled pipette tip of FIG. 1B, showing that the section 102 surrounds internal bore 106. FIG. 1D shows a schematic cross-sectional illustration of the assembled pipette tip of FIG. 1B taken along line 1D-1D, showing how insert portion 103 fits within receptacle portion 107, surrounding internal bore 105. FIG. 1E shows a schematic cross-sectional illustration of the assembled pipette tip of FIG. 1B taken along line 1E-1E, showing how section 104 surrounds internal bore 108.

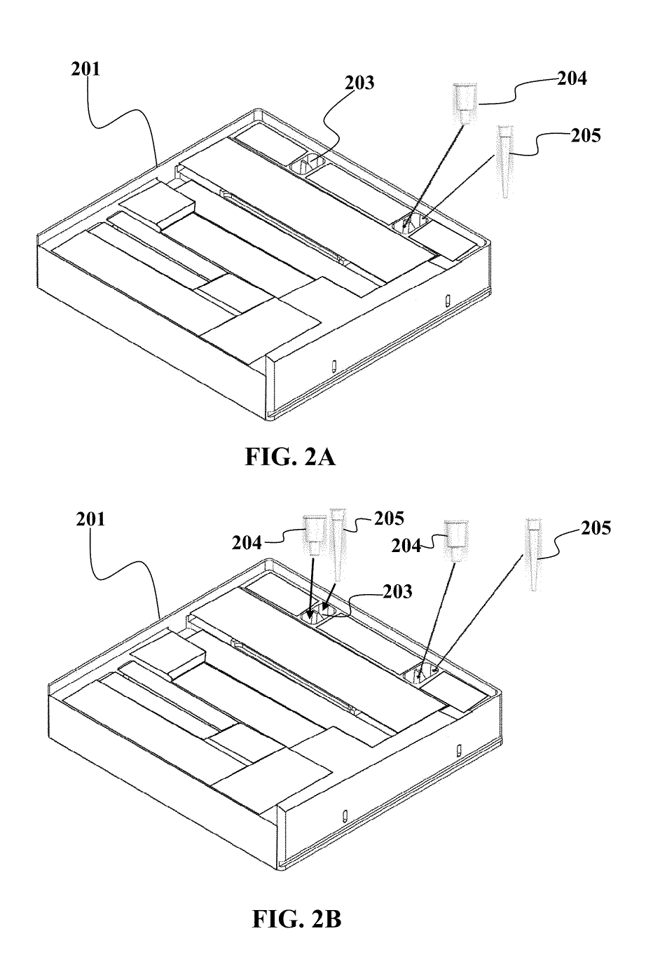

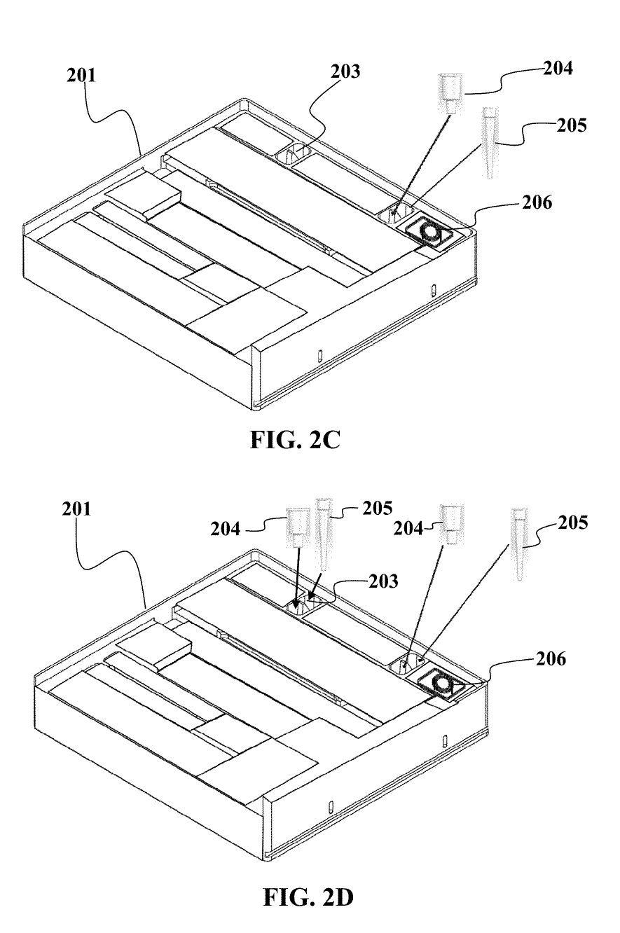

FIG. 2A shows a schematic illustration of a cartridge 201 containing a (dis-assembled) pipette tip (shown as sections 204 and 205). As indicated by the arrows, sections 204 and 205 may be placed in sockets 203 in the cartridge 201; there may be multiple sockets 203.

FIG. 2B shows a schematic illustration of a cartridge 201 containing two (dis-assembled) pipette tips which may be placed in sockets 203. The pipette tips are shown as sections 204 and 205.

FIG. 2C shows a schematic illustration of a cartridge 201 containing a (dis-assembled) pipette tip (shown as sections 204 and 205), the cartridge 201 also containing a sample 206.

FIG. 2D shows a schematic illustration of a cartridge 201 containing two (dis-assembled) pipette tips (shown as sections 204 and 205) which may be placed in sockets 203, the cartridge also containing a sample 206a.

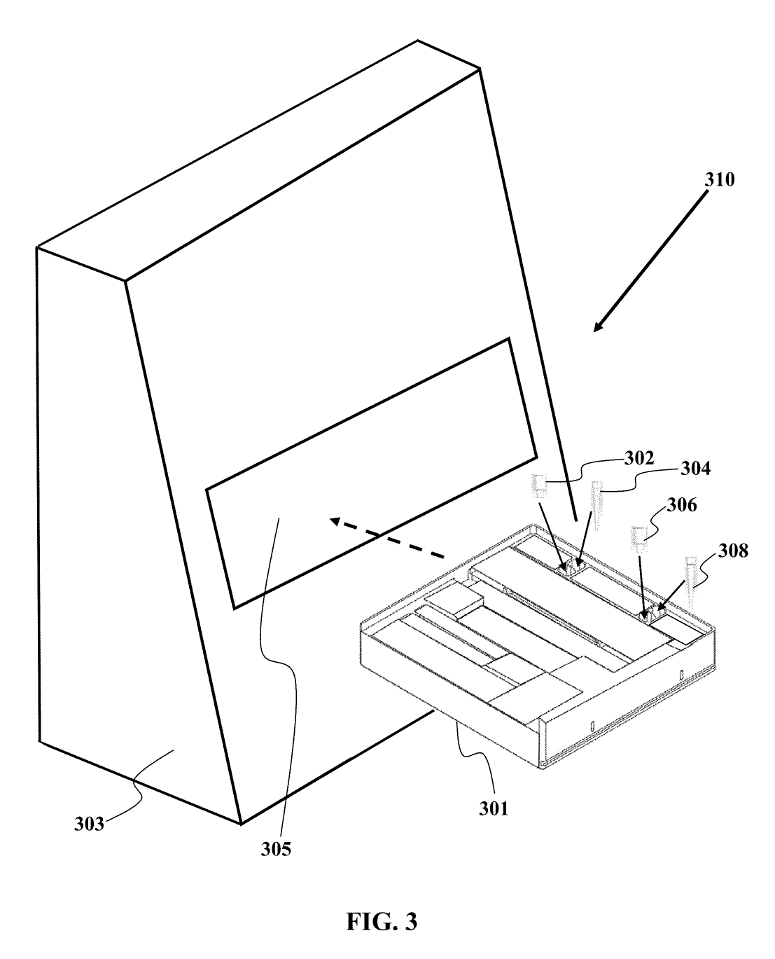

FIG. 3 shows a schematic illustration of a system 310 including a cartridge 301 containing two (dis-assembled) pipette tips (shown as sections 302 and 304, and as sections 306 and 308). As indicated by the arrow, the cartridge 301 may be inserted into slot 305 of the automated sample analysis device 303. The cartridge may optionally also contain a reagent, an implement, and a sample.

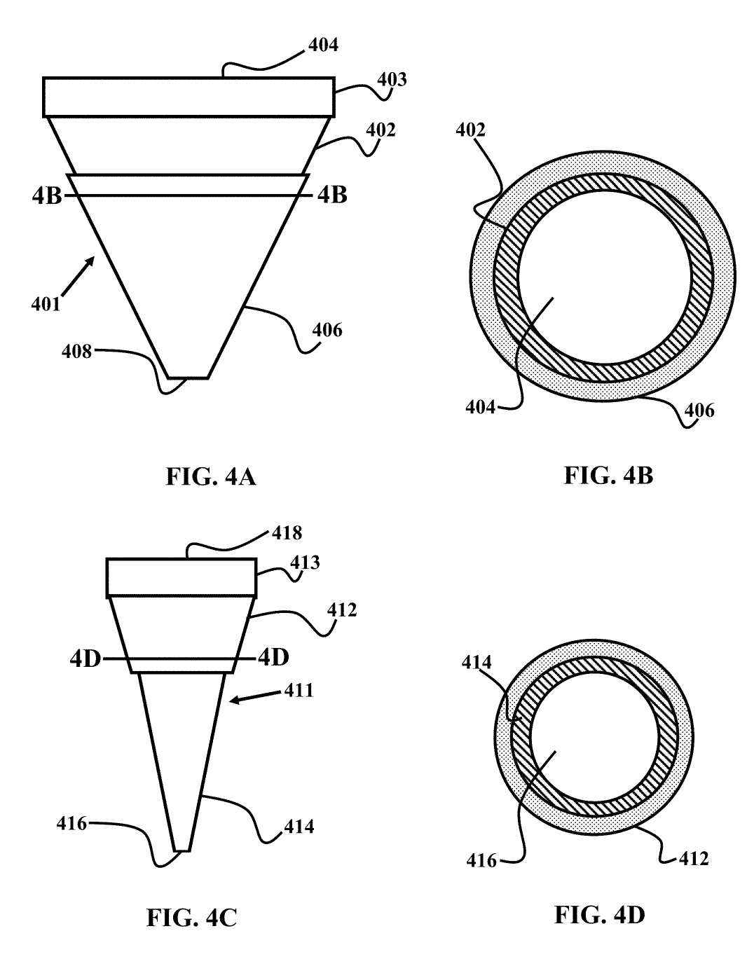

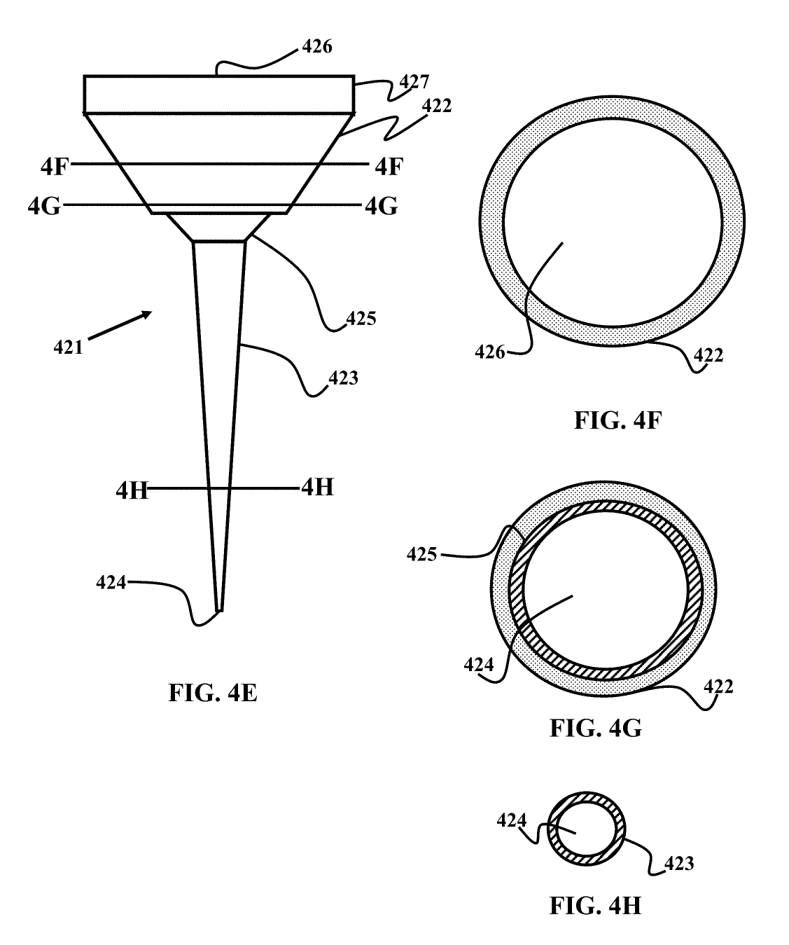

FIG. 4A shows a schematic perspective illustration of a wide pipette tip 401 having features disclosed herein, the pipette tip 401 having two sections, an upper section 402 having a rim 403, and a lower section 406. Internal bore 404 is indicated by the line directed to the upper portion of section 402. Internal bore 408 is indicated by the line directed to the aperture at the lower end of section 406. The pipette tip 401 is shown in assembled configuration.

FIG. 4B shows a schematic cross-sectional view of the assembled pipette tip 401 shown in FIG. 4A, the cross-section taken along line 4B-4B. Internal bore 404 is shown within the upper section 402, which upper section 402 fits within lower section 406 in the assembled configuration.

FIG. 4C shows a schematic perspective illustration of a narrow pipette tip 411 having features disclosed herein, the pipette tip 411 having two sections, an upper section 412 having a rim 413, and a lower section 414. Internal bore 418 is indicated by the line directed to the upper portion of section 412. Internal bore 416 is indicated by the line directed to the aperture at the lower end of section 414. The pipette tip 511 is shown in assembled configuration.

FIG. 4D shows a schematic cross-sectional view, the cross-section taken along line 4D-4D shown in FIG. 4C, showing internal bore 416 within the lower section 414, which lower section 414 fits within upper section 412 in the assembled configuration.

FIG. 4E shows a schematic perspective illustration of a pipette tip 421 having two sections and having multiple widths. Pipette tip 421 has a wider (upper) section 422 having a rim 427, and has a narrower (lower) section 423 having a tapered portion 425. Lower section 423 has an aperture leading to internal bore 424. Internal bore 426 of upper section 422 is also indicated in FIG. 4E. The pipette tip 421 is shown in assembled configuration.

FIG. 4F shows a schematic cross-sectional view of assembled pipette tip 421, the cross-section taken along line 4F-4F shown in FIG. 4E, showing internal bore 426 and upper section 422.

FIG. 4G shows a schematic cross-sectional view of assembled pipette tip 421, the cross-section taken along line 4G-4G shown in FIG. 4E, showing internal bore 424 within the tapered portion 425 of lower section 423, the tapered portion 425 being within upper section 422.

FIG. 4H shows a schematic cross-sectional view of assembled pipette tip 421, the cross-section taken along line 4H-4H shown in FIG. 4E, showing internal bore 424 within lower section 423.

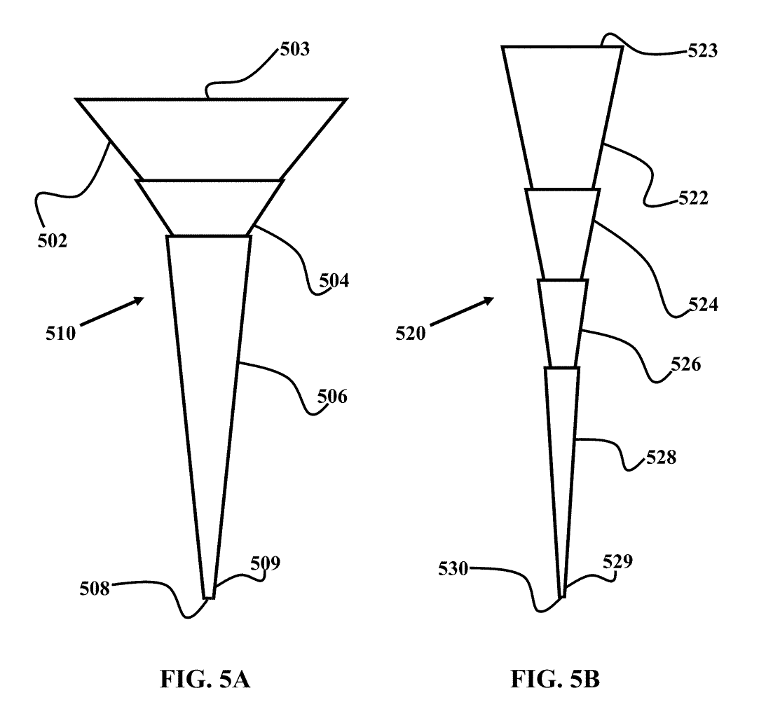

FIG. 5A shows a schematic perspective illustration of a pipette tip 510 having features disclosed herein, the pipette tip 510 having three sections, section 502 having an internal bore 503 indicated by a lead line directed at the upper portion of section 502; section 504; and section 506 having an aperture 509 at its distal end, leading to internal bore 508. Section 504 also has an internal bore (not shown). The internal bores 503, 508, and the internal bore of section 504 form a continuous internal bore when pipette tip 510 is in assembled configuration (as shown in FIG. 5A). The continuous internal bore of the assembled pipette tip 510 is a common feature for all the pipette tips disclosed herein when in an assembled configuration.

FIG. 5B shows a schematic perspective illustration of a pipette tip 520 having features disclosed herein, the pipette tip 520 having four sections. Section 522 having an internal bore 523 indicated by a lead line directed at the upper portion of section 522; section 524; section 526; and section 528 having an aperture 529 at its distal end, leading to internal bore 530. Sections 524 and 526 also have internal bores (not shown). The internal bores 523, 530, and the internal bores of sections 524 and 526 form a continuous internal bore when pipette tip 520 is in assembled configuration (as shown in FIG. 5B).

It will be understood that, in further embodiments of the fluid transfer devices disclosed herein, such as pipette tips as disclosed herein, may be comprised of more than four sections.

The assays and methods disclosed herein may be performed on a device, or on a system, for processing a sample. A device, or a system, for processing a sample may be an automated sample analysis device or system. The assays and methods disclosed herein can be readily incorporated into and used in an automated sample analysis device, and in an automated sample analysis system. For example, systems as disclosed herein may include a communication assembly for transmitting or receiving a protocol based on the analyte or analytes to be detected by the device or system. In embodiments, an assay protocol may be changed based on optimal scheduling of a plurality of assays to be performed by a device, or may be changed based on results previously obtained from a sample from a subject, or based on results previously obtained from a different sample from the subject. In embodiments, a communication assembly may comprise a channel for communicating information from said device to a computer, said wherein said channel is selected from a computer network, a telephone network, a metal communication link, an optical communication link, and a wireless communication link. In embodiments, systems as disclosed herein may transmit signals to a central location, or to an end user, and may include a communication assembly for transmitting such signals. Systems as disclosed herein may be configured for updating a protocol as needed or on a regular basis.

Devices for use with the fluid transfer devices disclosed herein may be configured to measure an analyte or multiple analytes in a sample of blood. Such devices may be configured to measure an analyte or multiple analytes from a sample of blood that comprises no more than about 1000 μL of blood but at least about 10 μL, or no more than about 500 μL of blood but at least about 10 μL, no more than about 250 μL of blood but at least about 10 μL, or no more than about 150 μL of blood but at least about 10 μL, or no more than about 100 μL of blood but at least about 10 μL, or no more than about 50 μL of blood but at least about 10 μL, or, in embodiments, wherein said sample of blood comprises no more than about 25 μL of blood but at least about 1 μL, or wherein said sample of blood comprises no more than about 10 μL of blood but at least about 10 μL, or wherein said sample of blood comprises less than about 10 μL of blood but at least about 10 μL. Such devices may be configured to measure an analyte or multiple analytes in a sample of blood in less than about one hour, or, in embodiments, in less than about 40 minutes, or in less than about 30 minutes.

Devices disclosed herein may be configured to perform an assay for the measurement of an analyte or multiple analytes and also to perform an assay for the measurement of another analyte in the blood sample. Devices disclosed herein may be configured to perform an assay for the measurement of an analyte or multiple analytes and also to perform an assay comprising the measurement of a morphological characteristic of a blood cell in the blood sample. Devices disclosed herein may be configured to perform an assay for the measurement of a first analyte and also to perform an assay comprising the measurement of another blood analyte, e.g., a vitamin, a hormone, a drug or metabolite of a drug, or other analyte. Such devices may be configured wherein the assays, or the order of performance of assays, that are performed by said device may be altered by communication with another device.

Applicants also disclose systems comprising a device as disclosed herein. In embodiments, the system comprises a device that is configured to perform an assay for the measurement of an analyte or multiple analytes and also to perform an assay for the measurement of another analyte in the blood sample. In embodiments, the system comprises a device that is configured to perform an assay for the measurement of an analyte or multiple analytes and also to perform an assay for the measurement of a morphological characteristic of a blood cell in the blood sample. In embodiments of such a system, assays, or the order of performance of assays, that are performed by said device may be altered by communication with another device.

Methods and compositions disclosed herein provide rapid assays which require only small amounts of sample, such as only small amounts of blood. Device and systems disclosed herein are configured to perform such rapid assays which require only small amounts of sample, such as only small amounts of blood. Accordingly, the methods, compositions, devices, and systems provide rapid tests, which require only small biological samples, and thus provide advantages over other methods, compositions, assays, devices, and systems.

The assays and methods disclosed herein may be performed on a device, or on a system, for processing a sample. The assays and methods disclosed herein can be readily incorporated into and used in device for processing a sample, or a system for processing a sample, which may be an automated sample analysis device, or may be an automated sample analysis system. Such a device, and such a system, may be useful for the practice of the methods disclosed herein. For example, a device may be useful for receiving a sample. A device may be useful for preparing, or for processing a sample. A device may be useful for performing an assay on a sample. A device may be useful for obtaining data from a sample. A device may be useful for transmitting data obtained from a sample. A device may be useful for disposing of a sample following processing or assaying of a sample.

A device may be part of a system, a component of which may be an automated sample analysis device. A device may be an automated sample analysis device. An automated sample analysis device may be configured to facilitate collection of a sample, prepare a sample for a clinical test, or effect a chemical reaction with one or more reagents or other chemical or physical processing, as disclosed herein. An automated sample analysis device may be configured to obtain data from a sample. An automated sample analysis device may be configured to transmit data obtained from a sample. An automated sample analysis device may be configured to analyze data from a sample. An automated sample analysis device may be configured to communicate with another device, or a laboratory, or an individual affiliated with a laboratory, to analyze data obtained from a sample.

An automated sample analysis device may be configured to be placed in or on a subject. An automated sample analysis device may be configured to accept a sample from a subject, either directly or indirectly. A sample may be, for example, a blood sample (e.g., a sample obtained from a fingerstick, or from venipuncture, or an arterial blood sample), a urine sample, a biopsy sample, a tissue slice, stool sample, or other biological sample; a water sample, a soil sample, a food sample, an air sample; or other sample. A blood sample may comprise, e.g., whole blood, plasma, or serum. An automated sample analysis device may receive a sample from the subject through a housing of the device. The sample collection may occur at a sample collection site, or elsewhere. The sample may be provided to the device at a sample collection site.

In some embodiments, an automated sample analysis device may be configured to accept or hold a cartridge. In some embodiments, an automated sample analysis device may comprise a cartridge. The cartridge may be removable from the automated sample analysis device. In some embodiments, a sample may be provided to the cartridge of the automated sample analysis device. Alternatively, a sample may be provided to another portion of an automated sample analysis device. The cartridge and/or device may comprise a sample collection unit that may be configured to accept a sample.

A cartridge may include a sample, and may include reagents for use in processing or testing a sample, disposables for use in processing or testing a sample, or other materials. Following placement of a cartridge on, or insertion of a cartridge into, an automated sample analysis device, one or more components of the cartridge may be brought into fluid communication with other components of the automated sample analysis device. For example, if a sample is collected at a cartridge, the sample may be transferred to other portions of the automated sample analysis device. Similarly, if one or more reagents are provided on a cartridge, the reagents may be transferred to other portions of the automated sample analysis device, or other components of the automated sample analysis device may be brought to the reagents. In some embodiments, the reagents or components of a cartridge may remain on-board the cartridge. In some embodiments, no fluidics are included that require tubing or that require maintenance (e.g., manual or automated maintenance).

A sample or reagent may be transferred to a device, such as an automated sample analysis device. A sample or reagent may be transferred within a device. Such transfer of sample or reagent may be accomplished without providing a continuous fluid pathway from cartridge to device. Such transfer of sample or reagent may be accomplished without providing a continuous fluid pathway within a device. In embodiments, such transfer of sample or reagent may be accomplished by a sample handling system (e.g., a pipette); for example, a sample, reagent, or aliquot thereof may be aspirated into an open-tipped transfer component, such as a pipette tip, which may be operably connected to a sample handling system which transfers the tip, with the sample, reagent, or aliquot thereof contained within the tip, to a location on or within the automated sample analysis device. The sample, reagent, or aliquot thereof can be deposited at a location on or within the automated sample analysis device. Sample and reagent, or multiple reagents, may be mixed using a sample handling system in a similar manner. One or more components of the cartridge may be transferred in an automated fashion to other portions of the automated sample analysis device, and vice versa.

A device, such as an automated sample analysis device, may have a fluid handling system. A fluid handling system may perform, or may aid in performing, transport, dilution, extraction, aliquotting, mixing, and other actions with a fluid, such as a sample. In some embodiments, a fluid handling system may be contained within a device housing. A fluid handling system may permit the collection, delivery, processing and/or transport of a fluid, dissolution of dry reagents, mixing of liquid and/or dry reagents with a liquid, as well as collection, delivery, processing and/or transport of non-fluidic components, samples, or materials. The fluid may be a sample, a reagent, diluent, wash, dye, or any other fluid that may be used by the device, and may include, but not limited to, homogenous fluids, different liquids, emulsions, suspensions, and other fluids. A fluid handling system, including without limitation a pipette, may also be used to transport vessels (with or without fluid contained therein) around the device. The fluid handling system may dispense or aspirate a fluid. The sample may include one or more particulate or solid matter floating within a fluid.

In embodiments, a fluid handling system may comprise a pipette, pipette tip, syringe, capillary, or other component. The fluid handling system may have portion with an interior surface and an exterior surface and an open end. The fluid handling system may comprise a pipette, which may include a pipette body and a pipette nozzle, and may comprise a pipette tip. A pipette tip may or may not be removable from a pipette nozzle. In embodiments, a fluid handling system may use a pipette mated with a pipette tip; a pipette tip may be disposable. A tip may form a fluid-tight seal when mated with a pipette. A pipette tip may be used once, twice, or more times. In embodiments, a fluid handling system may use a pipette or similar device, with or without a pipette tip, to aspirate, dispense, mix, transport, or otherwise handle the fluid. The fluid may be dispensed from the fluid handling system when desired. The fluid may be contained within a pipette tip prior to being dispensed, e.g., from an orifice in the pipette tip. In embodiments, or instances during use, all of the fluid may be dispensed; in other embodiments, or instances during use, a portion of the fluid within a tip may be dispensed. A pipette may selectively aspirate a fluid. The pipette may aspirate a selected amount of fluid. The pipette may be capable of actuating stirring mechanisms to mix the fluid within the tip or within a vessel. The pipette may incorporate tips or vessels creating continuous flow loops for mixing, including of materials or reagents that are in non-liquid form. A pipette tip may also facilitate mixture by metered delivery of multiple fluids simultaneously or in sequence, such as in 2-part substrate reactions.

The fluid handling system may include one or more fluidically isolated or hydraulically independent units. For example, the fluid handling system may include one, two, or more pipette tips. The pipette tips may be configured to accept and confine a fluid. The tips may be fluidically isolated from or hydraulically independent of one another. The fluid contained within each tip may be fluidically isolated or hydraulically independent from one fluids in other tips and from other fluids within the device. The fluidically isolated or hydraulically independent units may be movable relative to other portions of the device and/or one another. The fluidically isolated or hydraulically independent units may be individually movable. A fluid handling system may comprise one or more base or support. A base or support may support one or more pipette or pipette units. A base or support may connect one or more pipettes of the fluid handling system to one another.

An automated sample analysis device may be configured to perform processing steps or actions on a sample obtained from a subject. Sample processing may include sample preparation, including, e.g., sample dilution, division of a sample into aliquots, extraction, contact with a reagent, filtration, separation, centrifugation, or other preparatory or processing action or step. An automated sample analysis device may be configured to perform one or more sample preparation action or step on the sample. Optionally, a sample may be prepared for a chemical reaction and/or physical processing step. A sample preparation action or step may include one or more of the following: centrifugation, separation, filtration, dilution, enriching, purification, precipitation, incubation, pipetting, transport, chromatography, cell lysis, cytometry, pulverization, grinding, activation, ultrasonication, micro column processing, processing with magnetic beads, processing with nanoparticles, or other sample preparation action or steps. For example, sample preparation may include one or more step to separate blood into serum and/or particulate fractions, or to separate any other sample into various components. Sample preparation may include one or more step to dilute and/or concentrate a sample, such as a blood sample, or other biological samples. Sample preparation may include adding an anti-coagulant or other ingredients to a sample. Sample preparation may also include purification of a sample. In embodiments, all sample processing, preparation, or assay actions or steps are performed by a single device. In embodiments, all sample processing, preparation, or assay actions or steps are performed within a housing of a single device. In embodiments, most sample processing, preparation, or assay actions or steps are performed by a single device, and may be performed within a housing of a single device. In embodiments, many sample processing, preparation, or assay actions or steps are performed by a single device, and may be performed within a housing of a single device. In embodiments, sample processing, preparation, or assay actions or steps may be performed by more than one device.

An automated sample analysis device may be configured to run one or more assay on a sample, and to obtain data from the sample. An assay may include one or more physical or chemical treatments, and may include running one or more chemical or physical reactions. An automated sample analysis device may be configured to perform one, two or more assays on a small sample of bodily fluid. One or more chemical reaction may take place on a sample having a volume, as described elsewhere herein. For example one or more chemical reaction may take place in a pill having less than femtoliter volumes. In an instance, the sample collection unit is configured to receive a volume of the bodily fluid sample equivalent to a single drop or less of blood or interstitial fluid. In embodiments, the volume of a sample may be a small volume, where a small volume may be a volume that is less than about 1000 μL but greater than about 10 μL, or less than about 500 μL but greater than about 10 μL, or less than about 250 μL but greater than about 10 μL, or less than about 150 μL but greater than about 10 μL, or less than about 100 μL but greater than about 10 μL, or less than about 75 μL but greater than about 10 μL, less than about 50 μL but greater than about 5 μL, or less than about 40 μL but greater than about 5 μL, or less than about 20 μL but greater than about 1 μL, or less than about 10 μL but greater than about 1 μL, or other small volume. In embodiments, all sample assay actions or steps are performed on a single sample. In embodiments, all sample assay actions or steps are performed by a single device. In embodiments, all sample assay actions or steps are performed within a housing of a single device. In embodiments, most sample assay actions or steps are performed by a single device, and may be performed within a housing of a single device. In embodiments, many sample assay actions or steps are performed by a single device, and may be performed within a housing of a single device. In embodiments, sample processing, preparation, or assay actions or steps may be performed by more than one device.

An automated sample analysis device may be configured to perform a plurality of assays on a sample. In embodiments, an automated sample analysis device may be configured to perform a plurality of assays on a single sample. In embodiments, an automated sample analysis device may be configured to perform a plurality of assays on a single sample, where the sample is a small sample. For example, a small sample may have a sample volume that is a small volume of less than about 1000 μL but greater than about 10 μL, or less than about 500 μL but greater than about 10 μL, or less than about 250 μL but greater than about 10 μL, or less than about 150 μL but greater than about 10 μL, or less than about 100 μL but greater than about 10 μL, or less than about 75 μL but greater than about 10 μL, or less than about 50 μL but greater than about 5 μL, or less than about 40 μL but greater than about 5 μL, or less than about 20 μL but greater than about 1 μL, or less than about 10 μL but greater than about 1 μL, or other small volume. An automated sample analysis device may be capable of performing multiplexed assays on a single sample. A plurality of assays may be run simultaneously; may be run sequentially; or some assays may be run simultaneously while others are run sequentially. One or more control assays and/or calibrators (e.g., including a configuration with a control of a calibrator for the assay/tests) can also be incorporated into the device; control assays and assay on calibrators may be performed simultaneously with assays performed on a sample, or may be performed before or after assays performed on a sample, or any combination thereof. In embodiments, all sample assay actions or steps are performed by a single device. In embodiments, all of a plurality of assay actions or steps are performed within a housing of a single device. In embodiments, most sample assay actions or steps, of a plurality of assays, are performed by a single device, and may be performed within a housing of a single device. In embodiments, many sample assay actions or steps, of a plurality of assays, are performed by a single device, and may be performed within a housing of a single device. In embodiments, sample processing, preparation, or assay actions or steps may be performed by more than one device.

In embodiments, all of a plurality of assays may be performed in a short time period. In embodiments, such a short time period comprises less than about three hours, or less than about two hours, or less than about one hour, or less than about 40 minutes, or less than about 30 minutes, or less than about 25 minutes, or less than about 20 minutes, or less than about 15 minutes, or less than about 10 minutes, or less than about 5 minutes, or less than about 4 minutes, or less than about 3 minutes, or less than about 2 minutes, or less than about 1 minute, or other short time period.

An automated sample analysis device may perform nucleic acid assays, including isothermal nucleic acid assays (e.g., assays for detecting and measuring nucleic acid targets in a sample, including DNA and RNA targets). In embodiments, an automated sample analysis device may perform nucleic acid assays as disclosed in U.S. patent application Ser. No. 14/183,503, filed Feb. 18, 2014; U.S. patent application Ser. No. 14/214,850, filed Mar. 15, 2014; International Patent Application PCT/US2014/030034, filed Mar. 15, 2014; and in International Patent Application PCT/US2014/056151, filed Sep. 17, 2014. An automated sample analysis device may perform antibody assays, including enzyme-linked immunosorbent assays (ELISA), and other assays for detecting and measuring the amounts of proteins (including antibodies), peptides, and small molecules in samples. An automated sample analysis device may perform general chemistry assays, including electrolyte assays (e.g., assays for detecting and measuring the amounts of electrolytes such as sodium and potassium in a sample).

An automated sample analysis device may be configured to detect one or more signals relating to the sample. An automated sample analysis device may be configured to identify one or more properties of the sample. For instance, the automated sample analysis device may be configured to detect the presence or concentration of one analyte or a plurality of analytes or a disease condition in the sample (e.g., in or through a bodily fluid, secretion, tissue, or other sample). Alternatively, the automated sample analysis device may be configured to detect a signal or signals that may be analyzed to detect the presence or concentration of one or more analytes (which may be indicative of a disease condition) or a disease condition in the sample. The signals may be analyzed on board the device, or at another location. Running a clinical test may or may not include any analysis or comparison of data collected.

A chemical reaction or other processing step may be performed, with or without the sample. Examples of steps, tests, or assays that may be prepared or run by the device may include, but are not limited to immunoassay, nucleic acid assay, receptor-based assay, cytometric assay, colorimetric assay, enzymatic assay, electrophoretic assay, electrochemical assay, spectroscopic assay, chromatographic assay, microscopic assay, topographic assay, calorimetric assay, turbidmetric assay, agglutination assay, radioisotope assay, viscometric assay, coagulation assay, clotting time assay, protein synthesis assay, histological assay, culture assay, osmolarity assay, and/or other types of assays, centrifugation, separation, filtration, dilution, enriching, purification, precipitation, pulverization, incubation, pipetting, transport, cell lysis, or other sample preparation action or steps, or combinations thereof. Steps, tests, or assays that may be prepared or run by the device may include imaging, including microscopy, cytometry, and other techniques preparing or utilizing images. Steps, tests, or assays that may be prepared or run by the device may further include an assessment of histology, morphology, kinematics, dynamics, and/or state of a sample, which may include such assessment for cells.

A device may be capable of performing all on-board steps (e.g., steps or actions performed by a single device) in a short amount of time. A device may be capable of performing all on-board steps on a single sample in a short amount of time. For example, from sample collection from a subject to transmitting data and/or to analysis may take about 3 hours or less, 2 hours or less, 1 hour or less, 50 minutes or less, 45 minutes or less, 40 minutes or less, 30 minutes or less, 20 minutes or less, 15 minutes or less, 10 minutes or less, 5 minutes or less, 4 minutes or less, 3 minutes or less, 2 minutes or less, or 1 minute or less. The amount of time from accepting a sample within the device to transmitting data and/or to analysis from the device regarding such a sample may depend on the type or number of steps, tests, or assays performed on the sample. The amount of time from accepting a sample within the device to transmitting data and/or to analysis from the device regarding such a sample may take about 3 hours or less, 2 hours or less, 1 hour or less, 50 minutes or less, 45 minutes or less, 40 minutes or less, 30 minutes or less, 20 minutes or less, 15 minutes or less, 10 minutes or less, 5 minutes or less, 4 minutes or less, 3 minutes or less, 2 minutes or less, or 1 minute or less.

A device may be configured to prepare a sample for disposal, or to dispose of a sample, such as a biological sample, following processing or assaying of a sample.

In embodiments, an automated sample analysis device may be configured to transmit data obtained from a sample. In embodiments, an automated sample analysis device may be configured to communicate over a network. An automated sample analysis device may include a communication module that may interface with the network. An automated sample analysis device may be connected to the network via a wired connection or wirelessly. The network may be a local area network (LAN) or a wide area network (WAN) such as the Internet. In some embodiments, the network may be a personal area network. The network may include the cloud. The automated sample analysis device may be connected to the network without requiring an intermediary device, or an intermediary device may be required to connect an automated sample analysis device to a network. An automated sample analysis device may communicate over a network with another device, which may be any type of networked device, including but not limited to a personal computer, server computer, or laptop computer; personal digital assistants (PDAs) such as a Windows CE device; phones such as cellular phones, smartphones (e.g., iPhone, Android, Blackberry, etc.), or location-aware portable phones (such as GPS); a roaming device, such as a network-connected roaming device; a wireless device such as a wireless email device or other device capable of communicating wireless with a computer network; or any other type of network device that may communicate possibly over a network and handle electronic transactions. Such communication may include providing data to a cloud computing infrastructure or any other type of data storage infrastructure which may be accessed by other devices.

An automated sample analysis device may provide data regarding a sample to, e.g., a health care professional, a health care professional location, such as a laboratory, or an affiliate thereof. One or more of a laboratory, health care professional, or subject may have a network device able to receive or access data provided by the automated sample analysis device. An automated sample analysis device may be configured to provide data regarding a sample to a database. An automated sample analysis device may be configured to provide data regarding a sample to an electronic medical records system, to a laboratory information system, to a laboratory automation system, or other system or software. An automated sample analysis device may provide data in the form of a report.

A laboratory, device, or other entity or software may perform analysis on data regarding a sample in real-time. A software system may perform chemical analysis and/or pathological analysis, or these could be distributed amongst combinations of lab, clinical, and specialty or expert personnel. Analysis may include qualitative and/or quantitative evaluation of a sample. Data analysis may include a subsequent qualitative and/or quantitative evaluation of a sample. Optionally, a report may be generated based on raw data, pre-processed data, or analyzed data. Such a report may be prepared so as to maintain confidentiality of the data obtained from the sample, the identity and other information regarding the subject from whom a sample was obtained, analysis of the data, and other confidential information. The report and/or the data may be transmitted to a health care professional. Data obtained by an automated sample analysis device, or analysis of such data, or reports, may be provided to a database, an electronic medical records system, to a laboratory information system (LIS), to a laboratory automation system (LAS), or other system or software.

Description and disclosure of examples of reagents, assays, methods, kits, devices, and systems which may use, or be used with, the methods, devices, and systems disclosed herein may be found, for example, in U.S. Pat. No. 8,088,593; U.S. Pat. No. 8,380,541; U.S. Pat. No. 8,435,738; U.S. Pat. No. 8,475,739; U.S. Pat. No. 8,840,838; U.S. patent application Ser. No. 14/183,503, filed Feb. 18, 2014; U.S. patent application Ser. No. 13/933,035, filed Jul. 1, 2013; U.S. patent application Ser. No. 13/769,820, filed Feb. 18, 2013; U.S. patent application Ser. No. 14/183,503, filed Feb. 18, 2014; patent application Ser. No. 14/214,850, filed Mar. 15, 2014; International Patent Application PCT/US2014/030034, filed Mar. 15, 2014; International Patent Application PCT/US2014/056151, filed Sep. 17, 2014; U.S. patent application Ser. No. 13/769,798, filed Feb. 18, 2013; U.S. patent application Ser. No. 13/769,779, filed Feb. 18, 2013; U.S. patent application Ser. No. 13/244,947 filed Sep. 26, 2011; PCT/US2012/57155, filed Sep. 25, 2012; U.S. application Ser. No. 13/244,946, filed Sep. 26, 2011; U.S. patent application Ser. No. 13/244,949, filed Sep. 26, 2011; and U.S. application Ser. No. 13/945,202, filed Jul. 18, 2013, the disclosures of which patents and patent applications are all hereby incorporated by reference in their entireties.

While the invention has been described and illustrated with reference to certain particular embodiments thereof, those skilled in the art will appreciate that various adaptations, changes, modifications, substitutions, deletions, or additions of procedures and protocols may be made without departing from the spirit and scope of the invention. For example, with any of the above embodiments, it should be understood that the tip described herein may be configured for use with other cartridges or other devices and is not limited to those cartridges or devices described herein.

Additionally, concentrations, amounts, and other numerical data may be presented herein in a range format. It is to be understood that such range format is used merely for convenience and brevity and should be interpreted flexibly to include not only the numerical values explicitly recited as the limits of the range, but also to include all the individual numerical values or sub-ranges encompassed within that range as if each numerical value and sub-range is explicitly recited. For example, a size range of about 1 nm to about 200 nm should be interpreted to include not only the explicitly recited limits of about 1 nm and about 200 nm, but also to include individual sizes such as 2 nm, 3 nm, 4 nm, and sub-ranges such as 10 nm to 50 nm, 20 nm to 100 nm, etc. . . . .

The publications discussed or cited herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed. All publications mentioned herein are incorporated herein by reference to disclose and describe the structures and/or methods in connection with which the publications are cited. The following application is fully incorporated herein by reference for all purposes: U.S. Provisional Ser. No. 62/272,912 filed Dec. 30, 2015.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. Any feature, whether preferred or not, may be combined with any other feature, whether preferred or not. The appended claims are not to be interpreted as including means-plus-function limitations, unless such a limitation is explicitly recited in a given claim using the phrase “means for.” It should be understood that as used in the description herein and throughout the claims that follow, the meaning of “a,” “an,” and “the” includes plural reference unless the context clearly dictates otherwise. For example, a reference to “an assay” may refer to a single assay or multiple assays. Also, as used in the description herein and throughout the claims that follow, the meaning of “in” includes “in” and “on” unless the context clearly dictates otherwise. Finally, as used in the description herein and throughout the claims that follow, the meaning of “or” includes both the conjunctive and disjunctive unless the context expressly dictates otherwise. Thus, the term “or” includes “and/or” unless the context expressly dictates otherwise.

What is claimed is:

1. A fluid transfer device comprising:
a first section having a first internal bore, a proximal portion configured to operably engage with a fluid handling apparatus of an automated sample analysis device, and a distal portion, and
a second section having a second internal bore, a proximal portion configured to operably engage with said distal portion of said first section, and a distal portion comprising a tip having an aperture fluidically connected with said second internal bore,
said first section and said second section being configured for assembly together in an assembled configuration, wherein in said assembled configuration the distal portion of the first section is operably engaged with said proximal portion of said second section, effective to provide an assembled fluid transfer device;
wherein in said assembled fluid transfer device said first internal bore is fluidically connected with said second internal bore, whereby said assembled fluid transfer device comprises a composite internal bore comprising the first internal bore and the second internal bore, wherein said composite internal bore provides a continuous fluid connection between said aperture and said a proximal portion of the first section.

2. The fluid transfer device of claim 1, wherein said distal portion of said first section is configured to fit within said proximal portion of said second section, thereby providing operable engagement between said first and second sections to provide a fluid transfer device in said assembled configuration.

3. The fluid transfer device of claim 1, wherein said proximal portion of said second section is configured to fit within said distal portion of said first section, thereby providing operable engagement between said first and second sections to provide a fluid transfer device in said assembled configuration.

4. A system comprising the fluid transfer device of claim 1 and a cartridge, said cartridge configured to hold said fluid transfer device in a dis-assembled configuration, wherein the cartridge holds each of said first section and said second section of the fluid transfer device separately.

5. The system of claim 4, wherein said cartridge is configured to hold a plurality of fluid transfer devices.

6. The system of claim 5, wherein said cartridge holds each of said plurality of fluid transfer devices in a dis-assembled configuration.

7. A system comprising:
the fluid transfer device of claim 1;
a cartridge, said cartridge configured to hold said fluid transfer device in a dis-assembled configuration, wherein the cartridge holds each of said first section and said second section of the fluid transfer device separately; and
an automated sample analysis device.

8. The system of claim 7, wherein said cartridge is configured to hold a plurality of fluid transfer devices.

9. The system of claim 8, wherein said cartridge holds each of said plurality of fluid transfer devices in a dis-assembled configuration.

10. A kit containing a fluid transfer device of claim 1, a cartridge configured to hold said fluid transfer device in a dis-assembled configuration, wherein the cartridge holds each of said first section and said second section of the fluid transfer device separately, and instructions for the use of said fluid transfer device.

11. A kit containing a fluid transfer device of claim 1, a cartridge configured to hold said fluid transfer device in a dis-assembled configuration, wherein the cartridge holds each of said first section and said second section of the fluid transfer device separately, and a reagent for use in an assay performed by an automated sample analysis device.

12. A method of delivering a fluid transfer device to an automated sample analysis device, comprising:
Placing a first section of a fluid transfer device in a cartridge, wherein said cartridge is configured to operably engage with an automated sample analysis device;
Placing a second section of a fluid transfer device in said cartridge;
Engaging said cartridge with said automated sample analysis device, effective to deliver said fluid transfer device to said automated sample analysis device.

13. The method of claim 12, wherein said engaging said cartridge with said automated sample analysis device comprises inserting at least a portion of said cartridge into said automated sample analysis device.

14. The method of claim 12, further comprising said automated sample analysis device assembling said fluid transfer device effective to provide an assembled fluid transfer device.

15. The method of claim 14, further comprising said automated sample analysis device performing an assay, wherein performance of said assay by said automated sample analysis device comprises use of said assembled fluid transfer device.

16. The method of claim 12, wherein said cartridge further comprises a reagent for use in an assay performed by said automated sample analysis device.

17. The method of claim 15, further comprising said automated sample analysis device performing an assay, wherein performance of said assay by said automated sample analysis device comprises use of said fluid transfer device in an assembled configuration.

18. The method of claim 15, further comprising said automated sample analysis device performing an assay, wherein performance of said assay by said automated sample analysis device comprises use of said reagent.

19. The method of claim 15, further comprising said automated sample analysis device performing an assay, wherein performance of said assay by said automated sample analysis device comprises use of said fluid transfer device in an assembled configuration and use of said reagent.

20. A fluid transfer device comprising:
a first section having a first internal bore, a proximal portion configured to operably engage with a fluid handling apparatus of an automated sample analysis device, and a distal portion,
a second section having a second internal bore, a proximal portion configured to operably engage with said distal portion of said first section, and a distal portion, and
a third section having a third internal bore, a proximal portion configured to operably engage with said distal portion of said second section, and a distal portion comprising a tip having an aperture fluidically connected with said third internal bore,
said first section, said second section, and said third section being configured for assembly together in an assembled configuration, wherein in said assembled configuration the distal portion of the first section is operably engaged with said proximal portion of said second section, and said distal portion of the second section is operably engaged with said proximal portion of said third section, effective to provide an assembled fluid transfer device;
wherein in said assembled fluid transfer device said first internal bore is fluidically connected with said second internal bore and with said third internal bore; said second internal bore is fluidically connected with said first internal bore and with said third internal bore; and said third internal bore is fluidically connected with said first internal bore and with said second internal bore;
whereby said assembled fluid transfer device comprises a composite internal bore comprising the first internal bore, the second internal bore, and the third internal bore, wherein said composite internal bore provides a continuous fluid connection between said aperture and said a proximal portion of the first section.

21. The fluid transfer device of claim 20, wherein said distal portion of said first section is configured to fit within said proximal portion of said second section, and wherein said distal portion of said second section is configured to fit within said proximal portion of said third section, thereby providing operable engagement between said first, second, and third sections to provide a fluid transfer device in said assembled configuration.

22. The fluid transfer device of claim 20, wherein said proximal portion of said second section is configured to fit within said distal portion of said first section, and wherein said proximal portion of said third section is configured to fit within said distal portion of said second section, thereby providing operable engagement between said first, second, and third sections to provide a fluid transfer device in said assembled configuration.

23. The fluid transfer device of claim 20, wherein said proximal portion of said second section is configured to fit within said distal portion of said first section, and wherein said distal portion of said second section is configured to fit within said proximal portion of said third section, thereby providing operable engagement between said first, second, and third sections to provide a fluid transfer device in said assembled configuration.

24. The fluid transfer device of claim 20, wherein said distal portion of said first section is configured to fit within said proximal portion of said second section, and wherein said proximal portion of said third section is configured to fit within said distal portion of said second section, thereby providing operable engagement between said first, second, and third sections to provide a fluid transfer device in said assembled configuration.
